(19) United States
(12) Patent Application Publication
(10) Pub. No.: US 2009/0161735 A1
(43) Pub. Date: Jun. 25, 2009

(54) Direct sequence spread spectrum device and method for communication therewith

(75) Inventor: Mitsuji Okada, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,908

(22) Filed: Dec. 18, 2008

(30) Foreign Application Priority Data
Dec. 21, 2007 (JP) 330231/2007

(51) Int. Cl. H04B 1/707

(52) U.S. Cl. 375/150; 375/E01.003

(57) ABSTRACT

The communication device according to the present invention is a direct sequence spread spectrum device that performs a communication by using multiple different spread codes for multiple symbols. The direct sequence spread spectrum device according to the present invention includes: a correlation unit that calculates a correlation between each of the multiple different spread codes and a received signal spread by each of the multiple different spread codes, and that outputs a correlation degree for each of the spread codes; and a determination unit that demodulates the received signal to a symbol based on a value of the correlation degree for each of the spread codes.

### BACKGROUND OF THE INVENTION

1. Field of the Invention

The present invention relates to a communication device for direct sequence spread spectrum.

2. Description of the Related Art

In direct sequence spread spectrum (hereinafter, DSSS), on a transmitting side, a DSSS signal spread into a broadband is obtained by multiplying data by a pseudo noise code (hereinafter, spread code) faster than the data, and then the DSSS signal is transmitted. On a receiving side, the DSSS signal, is demodulated by multiplying the received DSSS signal by the same spread code as that on the transmitting side. In radio communication, since the data is influenced particularly by noises, multi-pass, or the like attributed to external environments, an error occurs in the data, which in turn leads to deterioration in communication quality. The DSSS is a communication scheme having enhanced resistance against interference and improved communication quality, by spreading the data into the broadband.

As a method for further improving the communication quality, a method of adding an error correcting code to the data so as to detect and correct the error is usually used.

Japanese Unexamined Patent Application Publication No. 08-046548 has disclosed a spread spectrum communication scheme in which error correction is performed using correlation degree of a received signal so as to minimize addition of redundant bits, so that a simple error correction circuit configuration is attained. In the spread spectrum communication scheme of Japanese Unexamined Patent Application Publication No. 08-046548, the transmitting side defines as one block a plurality of data bits of data to be transmitted, and adds redundant bits to detect the error for each block. The transmitting side performs spectrum spread modulation by using the spread code on the data bits of the data to be transmitted, and transmits the data. On the other hand, the receiving side demodulates the spread received data by using the same spread code as that on the transmitting side. The receiving side also generates a correlation signal that indicates the correlation degree between the received data and the spread code during this demodulation. The receiving side performs error detection of the demodulated received data by using the redundant bits added to each block. The receiving side performs error correction when detecting an error in the received data. In the error correction, the receiving side estimates the most interfered bit during transmission/reception, based on the data bit having the lowest correlation degree of the correlation signal between the received data and the spread code that is obtained at the time of demodulation. Accordingly, the receiving side performs the error correction by inverting the data bit having the lowest correlation degree of the correlation signal among the data bits of the data block where the error is detected.

However, when performing the error correction, addition of the error correcting code reduces the data transfer efficiency. For example, when performing the error correction using BCH (7, 4), the redundant bits of 3 bits are needed for performing 1-bit error correction on every 4-bit data. For this reason, the data transfer efficiency is reduced to 4/7. In the above-mentioned spread spectrum communication scheme of Japanese Unexamined Patent Application Publication No. 08-046548, 1-bit redundant bit for the error correction is added to every 8-bit data. Therefore, the data transfer efficiency is reduced to 8/9. If the data signal is transmitted with no redundant bit added thereto in order to avoid the reduction in the data transfer efficiency, the prior art cannot either detect or correct the bit influenced by noises. An object of the present invention is to solve such problem.

An object of the present invention is to provide a communication device that is capable of achieving excellent data transfer efficiency and high quality data transfer in DSSS.

### SUMMARY

The present invention seeks to solve one or more of the above problems, or to improve upon those problems at least in part. Hereinafter, means for solving the problem will be described by using reference numerals used in (Description of the Invention). These reference numerals are added in order to clarify a correspondence between descriptions of (What is claimed is:) and the (Description of the Invention). It should be noted that those numbers are not used for interpreting the technical scope of the invention described in (What is claimed is:).

A DSSS device according to the present invention is a DSSS device that performs communication by using multiple different spread codes for multiple symbols. The DSSS device includes: a correlation unit (30) that calculates a correlation between each of the multiple different spread codes and a received signal spread by each of the multiple different spread codes, and outputs a correlation degree for each of the spread codes; and a determination unit (43) that demodulates the received signal to a symbol based on the correlation degree for each of the spread codes.

In DSSS in which communication is performed by using multiple different spread codes for multiple symbols, a method for DSSS according to the present invention comprises the steps of: calculating a correlation between each of the multiple different spread codes and a received signal spread by each of the multiple different spread codes, and outputting a correlation degree for each of the spread codes; and demodulating the received signal to the symbol based on the correlation degree for each of the spread codes.

According to the present invention, it is possible to provide a communication device that is capable of achieving excellent data transfer efficiency and high quality data transfer in DSSS.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a correspondence table of a bit string, a symbol, and a spread code according to an embodiment of the present invention.

FIG. 2 is a functional block diagram according to the embodiment of the present invention.

FIG. 3 is a detailed circuit diagram according to the embodiment of the present invention.

FIG. 4 is a diagram showing a relationship between a correlation degree output and symbol determination according to the embodiment of the present invention.

FIG. 5 is a table showing a correlation degree between the spread codes according to the embodiment of the present invention.

### DESCRIPTION OF THE INVENTION

With reference to the accompanying drawings, a DSSS device according to an embodiment of the present invention will be described below.

### (Description of Transmitted and Received Data)

First, data received by the DSSS device (hereinafter, communication device) in the present embodiment will be described. In the present embodiment, the data is transmitted and received in accordance with the DSSS scheme specified in IEEE802.15.4 (2.4 GHz bandwidth).

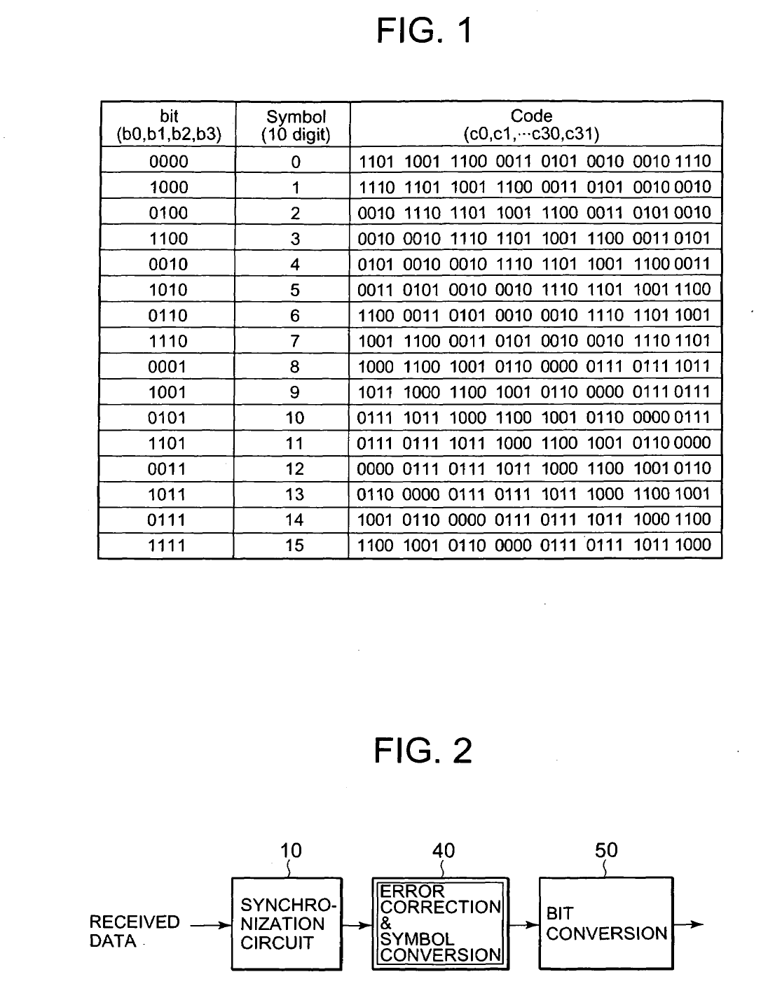

FIG. 1 is a correspondence table of a bit string of a data signal, a symbol, and a spread code specified in IEEE802.15.4 (2.4 GHz bandwidth). The correspondence table of FIG. 1 shows the bit string of 4 bits as 1 block, 16 types of the symbols respectively corresponding to 1-block bit patterns, and the spread codes respectively corresponding to the 16 types of the symbols.

In IEEE802.15.4 (2.4 GHz bandwidth), a transmitting terminal converts a data into a symbol based on one block formed of 4 bits. Next, the transmitting terminal modulates the symbol converted from the data to the 32-bit spread code corresponding to the symbol. Thereafter, the transmitting terminal performs Offset-QPSK modulation (hereinafter, O-QPSK modulation) on a carrier by using the 32-bit bit string of the spread code modulated from the symbol, and transmits the carrier.

With reference to FIG. 1, consider a case where one block of a bit string of a data signal transmitted by the transmitting terminal is “1011.” The transmitting terminal converts the bit string “1011” into the corresponding symbol “13.” Next, the transmitting terminal converts the symbol “13” into the corresponding spread code “0110 0000 0111 0111 1011 1000 1100 1001.” Then, using the bit string of the spread code “0110 0000 0111 0111 1011 1000 1100 1001,” the transmitting terminal performs O-QPSK modulation on the carrier, and transmits the carrier.

In the present embodiment, the data received by the communication device (hereinafter, received signal) is the signal that is subjected to the above-mentioned processing and transmitted.

### (General Description of Configuration)

FIG. 2 shows a functional block diagram of the communication device according to the present embodiment. The communication device of the present invention includes a synchronization circuit unit 10, an error correcting and symbol converting unit (hereinafter, symbol converting unit) 40, and a bit converting unit 50.

The synchronization circuit unit 10 synchronizes the received signal. The synchronization circuit unit 10 detects the head of the received signal, and outputs the synchronizing signal to the symbol converting unit 40 for every 32 bits. The synchronization circuit unit 10 outputs the synchronizing signal at a timing when one period of the symbol matches the 32-bit received signal outputted to correlators 30-0 to 30-15 by a shift register 20. The Shift register 20 and the correlators 30-0 to 30-15 will be described later.

The symbol converting unit 40 demodulates the received signal to the symbol. The symbol converting unit 40 calculates a correlation between the received signal and each of the 16 types of spread codes, in accordance with the synchronizing signal outputted by the synchronization circuit unit 10. The symbol converting unit 40 demodulates the received signal to the symbol based on the correlation degree between the received signal and each spread code. The symbol converting unit 40 outputs the symbol demodulated from the received signal, to the bit converting unit 50.

The bit converting unit 50 converts the symbol into a bit string. The symbol outputted by the symbol converting unit 40 is inputted into the bit converting unit 50. The bit converting unit 50 converts the inputted symbol into the 4-bit bit string as the correspondence table shown in FIG. 1. The bit converting unit 50 outputs the 4-bit bit string to a processing at a subsequent stage.

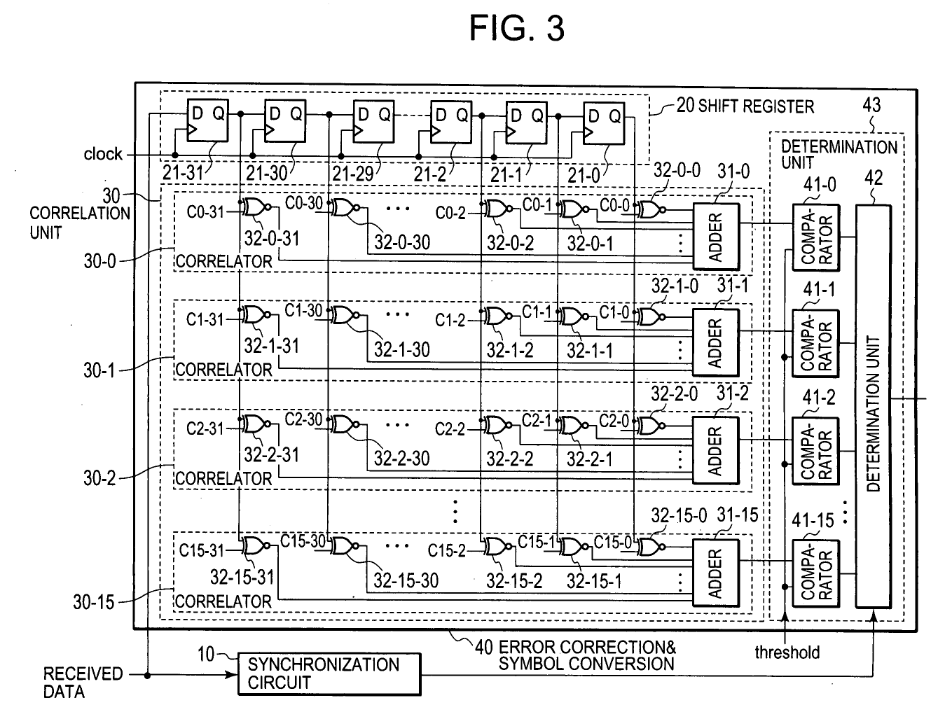

Details of the communication device according to the present embodiment will be described by using FIG. 3. FIG. 3 shows a detailed circuit configuration of the symbol converting unit 40 and the synchronization circuit 10 of the communication device of the present embodiment.

### (Description of the Synchronization Circuit Unit 10)

First, the synchronization circuit 10 will be described. The received signal is inputted into the synchronization circuit 10, and the synchronization circuit 10 outputs the synchronizing signal to a determiner 42 of a determination unit 43. The bit string of the received signal is inputted into the synchronization circuit 10. The synchronization circuit 10 outputs the synchronizing signal to the determiner 42 of the determination unit 43 for every 32 bits of the received signal. At clock time when the synchronization circuit 10 outputs the synchronizing signal, the determiner 42 determines symbol conversion.

### (Description of the Symbol Conversion Unit 40)

The symbol conversion unit 40 includes the shift register 20, a correlation unit 30, and the determination unit 43.

First, the shift register 20 will be described. The shift register 20 is formed of 32 flip-flops 21-0 to 21-31. As shown in FIG. 3, the 32 flip-flops 21-0 to 21-31 are connected in series. 1-bit of the received signal obtained from a processor of a front stage (not illustrated) is singly inputted into the firstly connected flip-flop 21-31. Other flip-flops 21-0 to 21-30 are configured so that the flip-flop may input a non-inverting terminal (hereinafter, Q terminal) output of the flip-flops 21-1 to 21-31 connected before the other flip-flops into a data terminal (hereinafter, D terminal) of the flip-flop. In accordance with the timing of the clock, the flip-flops 21-0 to 21-31 input 1-bit of the received signal into the D terminal singly, and output 1-bit of the received signal from the Q terminal singly. Following this manner, the flip-flops 21-0 to 21-31 output the received signal by shifting 1 bit of the received signal at a time. When the flip-flop 21-0 outputs an initial bit of the 32 bits corresponding to one period of the spread code, each of the flip-flops 21-0 to 21-31 outputs the 32 bits corresponding to one period of the spread code. In addition, the outputs of the flip-flops 21-0 to 21-31 is inputted into the correlators 30-0 to 30-15.

Next, the correlation unit 30 will be described. The correlation unit 30 includes the correlators 30-0 to 30-15. Each of the correlators 30-0 to 30-15 is formed of an exclusive “or” circuit (hereinafter, EXNOR circuit) having 32 NOTs, and of one adder. Each of the correlators 30-0 to 30-15 corresponds to the respective spread code of 16 types in one-to-one manner. Each of the correlators 30-0 to 30-15 calculates the correlation between one spread code corresponding to the respective correlator, and the received signal outputted by the flip-flops 21-0 to 21-31 of the shift register 20. Each of the correlators 30-0 to 30-15 calculates the correlation between the spread code and the received signal, by performing logical operation of each bit of one spread code corresponding to the respective correlator and of each bit of the received signal outputted by the flip-flops 21-0 to 21-31 of the shift register 20. Each of the correlators 30-0 to 30-15 calculates the correlation degree between the spread code corresponding to the respective correlator and the received signal, by adding the result of the logical operation of each bit. Each of the correlators 30-0 to 30-15 outputs the calculated correlation degree to the determination unit 43.

In the present embodiment, the correlator 30-0 calculates the correlation between the spread code corresponding to the symbol “0” and the received signal. The correlator 30-1 also calculates the correlation between the spread code corresponding to the symbol “1” and the received signal. Similarly, the correlators 30-2 to 30-15 calculate the correlation between the spread code corresponding to the respective symbols “2 to 15” and the received signal. In essence, the correlators 30-0 to 30-15 respectively calculate the correlation between the one corresponding spread code and the received signal.

Description of the correlation unit 30 will be given by using the correlator 30-0 as an example. The correlator 30-0 includes the EXNOR circuits 32-0-1 to 32-0-31 and the adder 31-0. The EXNOR circuits 32-0-0 to 32-0-31 input the outputs obtained from the flip-flops 21-0 to 21-31 of the shift register 20, into one input terminal of the EXNOR circuit. The EXNOR circuits 32-0-0 to 32-0-31 respectively correspond to the flip-flops 21-0 to 21-31. The output of the flip-flop 21-0 is inputted into the EXNOR circuit 32-0-0. The output of the flip-flop 21-1 is inputted into the EXNOR circuit 32-0-1. Similarly, the outputs of the flip-flops 21-2 to 21-31 are respectively inputted into the corresponding EXNOR circuits 32-0-2 to 32-0-31.

Each of the EXNOR circuits 32-0-0 to 32-0-31 inputs each bit of the spread code allocated to the correlator 30-0 into another respective input terminal of the EXNOR circuit. The symbol “0” is allocated to the correlator 30-0. The spread code “1101 1001 1100 0011 0101 0010 1110” corresponding to the symbol “0” is inputted into the EXNOR circuits 32-0-0 to 32-0-31. As shown in FIG. 1, when each bit of the spread code is respectively expressed as “c0 to c31,” a value “1” which is “c0” is inputted into the EXNOR circuit 32-0-0. A value “1” which is “c1” is inputted into the EXNOR circuit 32-0-1. Similarly, a value of each bit of “c2 to 31” is respectively inputted into the EXNOR circuits 32-0-2 to 32-0-31.

In essence, each bit of the spread code of the symbol “0” and each bit of the received signal outputted by the flip-flops 21-0 to 21-31 of the shift register 20 are respectively inputted into the EXNOR circuits 32-0-0 to 32-0-31.

Each of the EXNOR circuits 32-0-0 to 32-0-31 performs logical operation of the bit of the inputted spread code and the bit of the received signal. Each of the EXNOR circuits 32-0-0 to 32-0-31 outputs “1” when the bit of the inputted spread code and the bit of the received signal match each other, while outputting “0” when the bit of the inputted spread code and the bit of the received signal do not match each other. In other words, each of the EXNOR circuits 32-0-0 to 32-0-31 outputs “1” when the bit of both the inputted spread code and the bit of the received signal are “0” or “1,” while outputting “0” when one bit is “0” and the other bit is “1.” The EXNOR circuits 32-0-0 to 32-0-31 perform the logical operation of each bit of the spread code and each bit of the received signal at every clock time. The EXNOR circuits 32-0-0 to 32-0-31 respectively output the result of the logical operation to the adder 31-0 at every clock time.

The results of the logical operation outputted by the EXNOR circuits 32-0-0 to 32-0-31 are inputted into the adder 31-0. The adder 31-0 adds the results of the logical operation inputted from the EXNOR circuits 32-0-0 to 32-0-31 and then calculates the “correlation degree.”

The correlation degree calculated by the adder 31-0 is a degree of correlation between 32 bits of the received signal outputted by the shift register 20 and 32 bits of the spread codes of the symbol “0” allocated to the correlator 30-0, at a certain clock time. When all of the 32 bits of the received signal match the 32 bits of the spread code, all the outputs of the EXNOR circuits 32-0-0 to 32-0-31 are “1,” and therefore, the correlation degree becomes “32.” When the 32 bits of the received signal do not match with the 32 bits of the spread code, all the outputs of the EXNOR circuits 32-0-0 to 32-0-31 are “0,” and therefore, the correlation degree becomes “0.” Suppose a case where the received signal does not receive interference at all. If the correlation degree of the adder 31-0 is “32,” then it is possible to determine that the symbol transmitted by the transmitting side is “0” allocated to the correlator 30-0.

The above described is the description of the correlation unit 30, using the correlator 30-0 as an example. The correlators 30-1 to 30-15 serve in the same manner as the correlator 30-0 described above. The spread codes corresponding to the respective correlators 30-0 to 30-15 differ from each other, as above-mentioned. However, at certain clock time, all the received signals inputted into the correlators 30-0 to 30-15 from the shift register 20 are identical. Supposing that the received signal does not receive interference at all, it can be determined that the transmitted symbol is the symbol corresponding to one of the correlators 30-0 to 30-15 that outputs the correlation degree “32” among the correlation degrees outputted by the adders 31-0 to 31-15.

In the present embodiment, the correlation unit 30 includes the correlators 30-0 to 30-15, whose amount corresponds to the type of the spread code. However, a configuration of the correlator will not be limited to this. The correlation unit 30 may include only one correlator. In this case, the correlation between the received signal and all the spread codes may be calculated for every bit, by inputting the output of the received signal from the shift register 20 into the one correlator, and inputting the spread code into the 32 EXNOR circuits in time division. Similarly, the correlation unit 30 may include multiple correlators so that multiple spread codes correspond to the respective correlators. In this case, the correlation between the received signal and the spread code corresponding to each correlator are calculated, by inputting the output of the received signal from the shift register 20 into the multiple correlators, and inputting the spread code corresponding to each correlator to the 32 EXNOR circuits in time division, respectively,.

Next, the determination unit 43 will be described. The determination unit 43 includes comparators 41-0 to 41-15 and the determiner 42.

First, the comparators 41-0 to 41-15 will be described. The comparators 41-0 to 41-15 compare the correlation degrees outputted by the adders 31-0 to 31-15, with a threshold for these correlation degrees. The comparators 41-0 to 41-15 respectively correspond to the adders 31-0 to 31-15. The comparator 41-0 inputs the correlation degree outputted by the adder 31-0 into one input terminal of the comparator. The comparator 41-1 inputs the correlation degree outputted by the adder 31-1 in to one input terminal of the comparator. Similarly, the comparators 41-1 to 41-15 respectively input the correlation degrees outputted by the corresponding adders 31-1 to 31-15 into one respective input terminal of the comparator.

In addition, the comparators 41-0 to 41-15 input a threshold outputted by an external circuit (not illustrated) respectively into the other input terminal of the comparator. The threshold having the same value is inputted into each comparator 41-0 to 40-15.

The comparators 41-0 to 41-15 make a comparison to determine whether the correlation degree exceeds the threshold. When the correlation degrees exceed the threshold, the comparators 41-0 to 41-15 output “1,” as the comparison result, to the determiner 42. On the other hand, when the correlation degrees do not exceed the threshold, the comparators 41-0 to 41-15 output “0,” as the comparison result, to the determiner 42.

Next, the determiner 42 will be described. According to the comparison result outputted by the comparators 41-0 to 41-15, the determiner 42 determines the symbol to be demodulated, and outputs the determined symbol to the bit converting unit 50.

The comparison results outputted by the comparators 41-0 to 41-15 are inputted into the determiner 42. Additionally, the synchronizing signal outputted by the synchronization circuit 10 is inputted into the determiner 42. The synchronization circuit 10 monitors the received signal, and outputs the synchronizing signal for every 32 bits. A clock time at which the synchronization circuit 10 outputs the synchronizing signal is a timing at which the flip-flops 21-0 to 21-31 of the shift register 20 output the bit string corresponding to one period of the spread code of the received signal (32 bits corresponding to c0 to c31). At the clock time when the synchronizing signal is inputted from the synchronization circuit 10, the determiner 42 determines the comparison results inputted from the comparators 41-0 to 41-15.

The determiner 42 determines the symbol, as the symbol to be demodulated at the clock time, corresponding to one of the comparators 41-0 to 41-15 that outputs the comparison result “1” among the comparison results inputted from the comparators 41-0 to 41-15. The determiner 42 selects the symbol corresponding to the one of the comparators 41-0 to 41-15 that outputs the comparison result “1,” and then outputs the symbol to the bit converting unit 50.

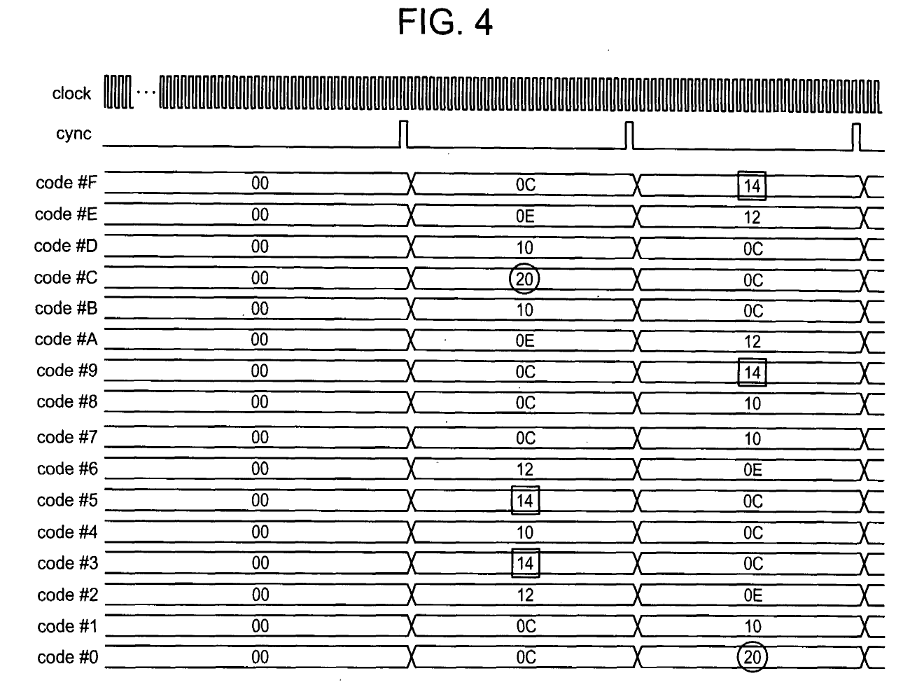

Comparison by the comparators 41-0 to 41-15 and determination by the determiner 42 will be described by using FIG. 4. FIG. 4 shows a relationship between the output of the adders 31-0 to 31-15 and symbol conversion. Items of FIG. 4 will be described. The item “clock” is a clock within a circuit in the present embodiment. The item “sync” indicates the synchronizing signal outputted by the synchronization circuit 10. The items “codes 0 to F” are the symbol represented by hexadecimal numbers, and each code indicates the output from the corresponding adders 31-0 to 31-15. Incidentally, an abscissa indicates the passage of time and the time passes from left to right.

According to FIG. 4, the first synchronizing signal is firstly inputted into the “sync.” This indicates that the synchronization circuit 10 detects the 32nd bit from the initial bit of the received signal, and outputs the synchronizing signal to the determiner 42. In the clock time herein, the values of “codes 0 to F” are the correlation degrees outputted by the corresponding adders 31-0 to 31-15. In this clock time, the correlation degree of “code C” is “20 (hexadecimal),” indicating that the output from the adder 31-12 is the correlation degree “32.” In other words, this implies that, in the EXNOR circuits 32-12-0 to 32-12-31 of the correlators 30-12, each bit of the received signal matches each bit of the spread code corresponding to the symbol “12” allocated to the correlator 30-12.

When the threshold inputted into the comparators 41-0 to 41-15 is set “26,” the comparator 41-12, to which the correlation degree “32” is inputted from the adder 31-12, outputs “1,” as the comparison result, to the determiner 42. On the other hand, the comparators except the comparator 41-12 output “0,” as the comparison result, to the determiner 42.

The comparison results outputted by the comparators 41-0 to 41-15 are inputted into the determiner 42. The determiner 42 detects that the comparison result of the comparator 41-12 is “1.” Thereby, the determiner 42 determines that the symbol “12” is the symbol to be demodulated at this clock time. The determiner 42 outputs the symbol “12” to the bit converting unit 50. Similarly, the synchronization circuit 10 further detects the 32nd bit of the received signal, and outputs the synchronizing signal to the next “sync.” When the next synchronizing signal is inputted, the determiner 42 detects that only the comparison result of the comparator 41-0 is “1”. Thereby, the determiner 42 determines that the symbol “0” is the symbol to be demodulated at this clock time. Following this procedure, the comparators 41-0 to 41-15 compare the outputs of the adders 31-0 to 31-15, while the determiner 42 determines the outputs of the comparators 41-0 to 41-15.

### (Description of the Threshold for the Correlation Degree)

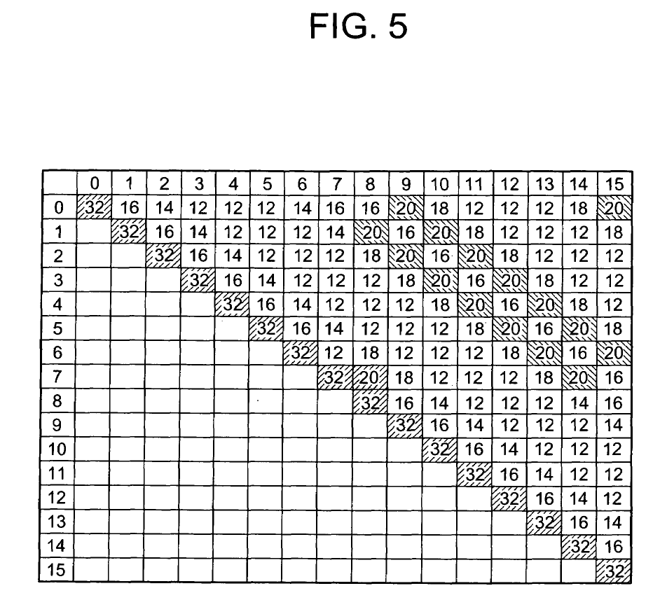

Next, an idea of the threshold used for comparison by the comparators 41-0 to 41-15 will be described with reference to FIG. 5. FIG. 5 shows a mutual correlation degree among the 16 types of spread codes. “0 to 15” in the row and column in FIG. 5 respectively indicate the symbols. The correlation degree among the spread codes corresponding to the symbols in the row and column is recorded on the table. By using the symbol “0” in the column as an example, a description of the table in FIG. 5 will be given. Since all the 32 bits of the spread codes corresponding to the both symbols “0” match each other, the correlation degree between the symbols “0” (symbol “0” in the ordinate and symbol “0” in the abscissa) is “32.” Similarly, the correlation degree between the symbol “0” and the symbol “1” is “16.” This shows that the number of each bit of the spread code of the symbol “0” matching each bit of the spread code of the symbol “1” coincide, is 16. Following this manner, in FIG. 5, the result obtained by calculating the correlation degrees among all the 16 types of the spread codes is recorded.

According to FIG. 5, the correlation degrees between the same symbols are “32.” Seeing the correlation degree between different symbols, it should be noticed that the correlation degree is “20” at the maximum. This in turn describes that the minimal value of an intersymbol distance is “12.” If the received signal does not receive interference at all, the correlators 30-0 to 30-15, to which the symbol matching the received signal is allocated, outputs the correlation degree “32.” On the other hand, it implies that the correlation degree output of the correlators 30-0 to 30-15 to which the symbol not matching the received signal is allocated is “20” at the maximum. In the present embodiment, the threshold for the correlation degree inputted into the comparators 41-0 to 41-15 is set within the range of the minimal value of the intersymbol distance. This setting allows the determiner 42 to make a reliable determination on the symbol to be demodulated.

The threshold set for any value from “21 to 32” determines the number of bits of bit errors to be tolerated and corrected, the bit errors occurring in the received signal. Assume, for example, that the correlation degree “26.” is set as the threshold. In this case, even when the received signal undergoes 5-bit of bit errors, the determination unit 43 does not mistake the symbol to be demodulated. The correlators 30-0 to 30-15 all receive a same effect even when the bit error occurs in the received signal, since the same bit string is inputted from the shift register 20 into each of the correlators 30-0 to 30-15. Therefore, it is not only the correlator corresponding to the spread code of the symbol to be demodulated that is influenced. Moreover, since the spread codes corresponding to the correlators 30-0 to 30-15 have different bit arrays, the correlation values outputted by the correlators 30-0 to 30-15 are different depending on which bit of the received signal undergoes an error.

The threshold will be described with reference to FIG. 4. According to the correlation degree outputs of the correlators 30-0 to 30-15 at the clock time when the first synchronizing signal is outputted from the synchronization circuit 10 as shown in FIG. 4, it can be found that the code “C” is “20 (hexadecimal).” In this case, it is estimated that no bit error occurs in the received signal by the interference during transmission/reception. The code “3” and code “5” have the correlation degree “14 (hexadecimal).” In addition, the correlation degrees of the codes “3” and “5” are “14 (hexadecimal).” This is the same as the correlation degree between the symbol “12” corresponding to the code “C” and the symbol “3” corresponding to the code “3,” and the correlation degree between the symbol “12” corresponding to the code “C” and the symbol “5” corresponding to the code “5” in FIG. 4.

As mentioned above, assume the correlation degree “26” is set as the threshold. In this case, if 5 bits of the bit error have occurred in the received signal, the correlation degree of the symbol “12” is “27.” When between the spread code of the symbol “12” and the spread code of the symbol “3” or the symbol “5,” 5 bits are errors in the bits in which “0” and “1” are different, the correlation degree between the symbol “12” and the symbol “3” or the symbol “5” is “25.” Thus, even when the 5 bits having the error are the worst bit error between the respective spread codes, the determination unit 43 does not mistake determination.

In the present embodiment, the threshold is set for the correlation degree “26.” However, the threshold will not be limited to this. It is preferable that the threshold should be set within the range of the minimal value of the intersymbol distance (correlation degree “21 to 32” in the present embodiment). This ensures proper determination by the determination unit 43. The threshold may be dynamically varied in accordance with an interfering state of the received signal. For example, it is possible to provide a separate circuit that detects the number of the bit errors that the received signal undergoes, and to set the threshold dynamically higher or lower in response to the bit error condition of the received signal. This allows the threshold setting to be adjusted in response to the interfering state during transmission/reception.

In the present embodiment, the comparators 41-0 to 41-15 make a determination by using the threshold for the correlation degree. Instead of this, the determination method of comparing a value of the correlation degrees outputted by the adders 31-0 to 30-15 may be used. In this case, the symbol corresponding to the correlator 30-0 to 30-15 that have one of the adders 31-0 to 31-15 that outputs the largest value among the correlation degrees outputted by the adders 31-0 to 31-15, is determined to be the symbol to be demodulated. This allows determination of the symbol to be demodulated even when the interfering state during transmission/reception is worse and the threshold has to be set for a lower value, or even when the correlation degree exceeding the threshold cannot be obtained. In addition, the symbol to be demodulated may be also determined by combining or switching determination made by the threshold and determination made by the largest value of the correlation degree.

As mentioned above, the flip-flops 21-0 to 21-31 of the shift register 20 output the received signal, by shifting 1 bit of the received signals at a time. The EXNOR circuits 32-0-0 to 32-15-31 of the correlators 30-0 to 30-15 perform logical operation of each bit of the received signal outputted by the flip-flops 21-0 to 21-31 of the shift register 20 and each bit of the spread signal allocated to each of the correlators 30-0 to 30-15. The adders 31-0 to 31-31 of the correlators 30-0 to 30-15 calculate the correlation degree for the received signal for every spread code by adding the results of the logical operation. The comparators 41-0 to 41-15 of the determination unit 43 compare the correlation degree outputted by the adders 31-0 to 31-31, with the threshold for the correlation degree, and output the comparison result. At the timing when the synchronizing signal is inputted from the synchronization circuit 10, the determiner 42 determines the comparison results outputted by the comparators 41-0 to 41-15, identifies the symbol to be demodulated, demodulates the spread code to the symbol, and then output the symbol. The bit converting unit 50 converts the symbol outputted by the determiner 42 into the 4-bit bit string.

Thus, according to the DSSS device of the present invention, the correlation degree between the received signal and the spread code is calculated, and the symbol is determined by using the threshold for the correlation degree. Thereby, even when interference during transmission/reception causes the bit error in multiple bits of the received signal, it is possible to determine the symbol to be demodulated without a mistake. Furthermore, the value of the threshold for the correlation degree is varied within the range of the minimal value of the intersymbol distance in the spread code used for spreading. Thereby, it is also possible to adjust the tolerance value of the bit error for the received signal in response to the interfering state during transmission/reception. Thus, at the demodulation stage of converting the received signal into the symbol, it is possible to eliminate effect of the bit error in the received signal. Therefore, data transfer of high quality can be implemented, without adding an error correcting code to an unnecessary data signal, on the transmitting side. Accordingly, since it becomes unnecessary to add the unnecessary error correcting code on the transmitting side, it is possible to implement high data transfer efficiency.

In the present embodiment, the data signal is transmitted and received in accordance with the DSSS system specified to IEEE802.15.4, but the present invention will not be limited to this. As long as it is a spread spectrum communication system in which the spread code corresponding to the symbol is fixed during transmission/reception, the present invention is capable of making a determination of the symbol to be demodulated. With this, high quality data transfer and high data transmission efficiency can be achieved without adding the error correcting code.

It is apparent that the present invention is not limited to the above embodiments, but may be modified and changed without departing from the scope and sprit of the invention.

What is claimed is:

1. A direct sequence spread spectrum device that performs a communication by using a plurality of different spread codes for a plurality of symbols, the direct sequence spread spectrum device comprising:
a correlation unit that calculates a correlation between a received signal and each of the plurality of different spread codes, and that outputs a correlation degree for each of the spread codes; and
a determination unit that demodulates the received signal to a symbol based on a value of the correlation degree for each of the spread codes.

2. The direct sequence spread spectrum device according to claim 1, wherein
the determination unit demodulates the received signal to the symbol corresponding to a spread code, among the spread codes, that represents a correlation degree exceeding a predetermined threshold, and
the threshold is determined in a range of the minimal intersymbol distance between the spread codes.

3. The direct sequence spread spectrum device according to claim 2, wherein
the determination unit changes the threshold in response to a reception state of the received signal.

4. The direct sequence spread spectrum device according to claim 1, wherein
the determination unit demodulates the received signal to the symbol corresponding to a spread code, among the spread codes, that indicates the largest correlation degree.

5. The direct sequence spread spectrum device according to claim 1, further comprising:
a synchronization circuit unit that detects one period of the spread code and outputs a synchronizing signal;
wherein the correlation unit includes a plurality of correlators that output the correlation degrees corresponding respectively to the plurality of different spread codes, and
the determination unit demodulates the received signal to the symbol when the synchronizing signal is inputted.

6. The direct sequence spread spectrum device according to claim 1, further comprising:
a bit converting unit that converts the symbol into a bit string.

7. A method for communicating in direct sequence spread spectrum in which communication is performed by using a plurality of different spread codes for a plurality of symbols, the method comprising:
calculating a correlation between each of the plurality of different spread codes and a received signal, and outputting a correlation degree for each of the spread codes; and
demodulating the received signal to a symbol based on a value of the correlation degree for each of the spread codes.

8. The method for communicating in direct sequence spread spectrum according to claim 7, wherein
the demodulating comprises demodulating the received signal to a symbol corresponding to a spread code, among the respective spread codes, that indicates a correlation degree exceeding a predetermined threshold determined in a range of a minimal intersymbol distance between the spread codes.

9. The method for communicating in direct sequence spread spectrum according to claim 8, wherein
the demodulating comprises changing the threshold in response to a reception state of the received signal.

10. The method for communicating in direct sequence spread spectrum according to claim 7, wherein
the demodulating comprises demodulating the received signal to the symbol corresponding to a spread code, among the respective spread codes, that indicates the largest correlation degree.

11. The method for communicating in direct sequence spread spectrum according to claim 7, further comprising detecting one period of the spread code and outputting a synchronizing signal.

12. The method for communicating in direct sequence spread spectrum according to claim 11, wherein
the demodulating comprises demodulating the received signal to the symbol when the synchronizing signal is inputted.

13. The method for communicating in direct sequence spread spectrum according to claim 7, further comprising converting the symbol into a bit string.
